(19) United States
(12) Patent Application Publication
(10) Pub. No.: US 2010/0110894 A1
(43) Pub. Date: May 6, 2010

(54) AUTOMATIC PROVISIONING OF A REMOTE TEST HEAD OF A COMBINED IP/TELEPHONY/CABLE NETWORK

(75) Inventor: Roger A. Smith, Gibsonia, PA (US)

Correspondence Address: THE WEBB LAW FIRM, P.C., 700 KOPPERS BUILDING, 436 SEVENTH AVENUE, PITTSBURGH, PA, 15219, US

(73) Assignee: TOLLGRADE COMMUNICATIONS, INC., Wilmington, DE (US)

(21) Appl. No.: 12/441,972

(22) PCT Filed: Sep. 19, 2007
(86) PCT No.: PCT/US07/78865

§ 371 Date: Dec. 16, 2009

Related U.S. Application Data
(60) Provisional application No. 60/846,191, filed on Sep. 21, 2006.

(51) Int. Cl. H04L 12/26

(52) U.S. Cl. 370/241

(57) ABSTRACT

In a telecommunications network that includes: a Digital Subscriber Line Access Multiplexer (DSLAM) (4) that has a DSLAM ID assigned thereto, a test head (2) coupled to the DSLAM (4) including a VLAN ID and a MAC address, and an auto-provisioning server (10), a public IP network is created between the auto-provisioning server (10) and a Test Operations Support System (OSS) (14) coupled to the telecommunications network. A private IP network is created between the test head (2) and the auto-provisioning server (10). The auto-provisioning server (10) acts as a gateway for the dispatch of data from the test head (2) to the Test OSS, and vice versa, across the private VLAN network and the public IP network.

### BACKGROUND OF THE INVENTION

1. Field of the Invention

The present invention relates to testing of telecommunications networks and, more particularly, to provisioning of a test head in the telecommunications network.

2. Description of Related Art

As the traditional telecommunications network evolves from a traditional Hub and Spoke model to a more distributed architecture to support the so-called “triple play”, namely, broadband internet, telephone and cable television/video-on-demand, the cost associated with testing will increase unless test providers leverage the benefits of the new network architecture.

Installation costs of test equipment typically increases as networks become more distributed. Instead of sending a repair technician to a central site that may address 10,000 or more subscribers, each distributed network remote site may serve as few as 100 customers. The time a technician spends at the remote site installing test equipment and troubleshooting subscriber issues is a critical factor when considering a business case associated with testing.

Traditional steps to add a test head to an IP network include:

(1) Pre-assign a static IP address to the test head.

(2) Record the ID of the Digital Subscriber Line Access Multiplexer (DSLAM), i.e., the DSLAM ID, where the test head will be physically installed. A DSLAM is a device that terminates all the customer lines, e.g., DSL lines, serviced thereby. More specifically, each DSLAM consolidates or concentrates all the data traffic coming from individual customers or DSL lines coupled to the DSLAM and passes such data traffic onto a high-speed backbone network for distribution to Internet Service Provider networks or corporate networks, and vice versa. A DSLAM can provide both phone service and high-speed internet service to a subscriber.

(3) Next, the test head is installed at the DSLAM. The test head is manually configured with the pre-assigned IP address and a record is made of the Media Access Control (MAC) address of the test head that was installed. A MAC address is a unique code assigned to most forms of networking hardware. The address is permanently assigned to the hardware, thereby limiting a wireless network's access to hardware, such as wireless cards, and is a security feature employed by closed wireless networks.

(4) Lastly, once installation of the test head is complete, the IP address and MAC address of the test head is entered into a test head database accessible to a Test Operations Support System (OSS) that can initiate tests on DSL lines serviced by the DSLAM.

This process is typically time and labor intensive.

### SUMMARY OF THE INVENTION

An embodiment of the invention is a method of testing a telecommunications network, the telecommunications network comprised of a Digital Subscriber Line Access Multiplexer (DSLAM) that has a DSLAM ID assigned thereto, a test head coupled to the DSLAM and including a VLAN ID and a MAC address, and an auto-provisioning server. The method includes (a) causing the test head to request a private IP address from the auto-provisioning server via the DSLAM, said request including the test head's VLAN ID and MAC address; (b) causing the DSLAM to append its DSLAM ID to the request in step (a); (c) following steps (a) and (b), causing the auto-provisioning server to assign a private IP address to the test head; (d) causing the auto-provisioning server to output the private IP address to the test head via the DSLAM utilizing the test head's VLAN ID and MAC address; (e) causing the test head to associate itself with the output private IP address; (f) creating in a first database accessible to the auto-provisioning server, a relationship between the private IP address and the DSLAM ID; (g) creating in a second database accessible to a Test Operations Support System (OSS) coupled to the telecommunications network, a relationship between the DSLAM ID and a network address of the auto-provisioning server; (h) causing the Test OSS to output to the network address of the auto-provisioning server a test request that includes the corresponding DSLAM ID retrieved from the second database; (i) in response to the test request including the DSLAM ID, causing the auto-provisioning server to retrieve from the first database the private IP address corresponding to the DSLAM ID; (j) causing the auto-provisioning server to forward the test request to the test head via the DSLAM utilizing the private IP address; and (k) in response to the forwarded test request in step (j), causing the test head to run at least one test on a customer circuit coupled to the DSLAM.

The method can further include between steps (j) and (k), the step of causing the DSLAM to connect the customer circuit to the test head based on data regarding the customer circuit included in the test request output by the Test OSS in step (h).

The method can further include: (l) following step (k), causing the test head to report the results of the at least one test on the customer circuit to the Test OSS via the DSLAM and the auto-provisioning server; and (m) following step (l), causing the DSLAM to release the customer circuit.

The DSLAM can include a rule that routes each communication from the test head that includes the VLAN ID to the auto-provisioning server and routes each communication from the auto-provisioning server that includes the private ID address to the test head.

The telecommunications network can include a network switch in the communication path between the DSLAM and the auto-provisioning server. The network switch can include a rule that routes each communication from the DSLAM that includes the VLAN ID to the auto-provisioning server and routes each communication from the auto-provisioning server that includes the private ID address to the DSLAM.

The customer circuit can be a DSL line.

Another embodiment of the invention is a method of testing a telecommunications network, the telecommunications network comprised of a Digital Subscriber Line Access Multiplexer (DSLAM) that has a DSLAM ID assigned thereto, a test head coupled to the DSLAM and including a VLAN ID and a MAC address, and an auto-provisioning server. The method includes (a) creating a public IP network between the auto-provisioning server and a Test Operations Support System (OSS) coupled to the telecommunications network, wherein the auto-provisioning server and the Test OSS each include a unique static IP address on the public IP network; (b) creating a private VLAN network between the test head and the auto-provisioning server, wherein the test head is assigned a unique private IP address on the private IP network by the auto-provisioning server; and (c) causing the auto-provisioning server to act as a gateway for the dispatch of data from the test head to the Test OSS, and vice versa, across the private VLAN network utilizing the private IP address and across the public IP network utilizing static IP addresses, wherein the data dispatched from the Test OSS to the test head includes a test request and the data dispatched from the test head to the Test OSS includes test results of a test performed by the test head on a customer circuit coupled to the DSLAM.

The private VLAN network can be created between the test head and the auto-provisioning server via the DSLAM utilizing the VLAN ID, the MAC address and the DSLAM ID.

Step (b) can include the steps of: the test head requesting a private IP address from the auto-provisioning server via the DSLAM, said request including the test head's VLAN ID and MAC address; the DSLAM appending its DSLAM ID to the private IP address request; the auto-provisioning server assigning a private IP address to the test head in response to the server receiving the private IP address request including the DSLAM ID and the test head's VLAN ID and MAC address; the auto-provisioning server outputting the assigned private IP address to the test head via the DSLAM utilizing the test head's VLAN ID and MAC address; and the test head associating itself with the output private IP address in response to receiving it from the auto-provisioning server via the DSLAM.

The method can further include: creating in a first database accessible to the auto-provisioning server a relationship between the private IP address and the DSLAM ID; and creating in a second database accessible to a Test Operations Support System (OSS) coupled to the telecommunications, network a relationship between the DSLAM ID and a network address of the auto-provisioning server.

The method can further include: causing the Test OSS to output to the network address of the auto-provisioning server a test request that includes the corresponding DSLAM ID retrieved from the second database; in response to the test request including the DSLAM ID, causing the auto-provisioning server to retrieve from the first database the private IP address corresponding to the DSLAM ID; causing the auto-provisioning server to forward the test request to the test head via the DSLAM utilizing the private IP address; and in response to the forwarded test request, causing the test head to run at least one test on a customer circuit coupled to the DSLAM.

The customer circuit can be a DSL line.

The telecommunications network can further include a switch in the communication path between the auto-provisioning server and the DSLAM and operative for passing communications between the auto-provisioning server and the DSLAM.

Lastly, an embodiment of the invention includes a telecommunications network that comprises: a Digital Subscriber Line Access Multiplexer (DSLAM) that has a DSLAM ID assigned thereto; a test head coupled to the DSLAM, the test head having a VLAN ID and a MAC address assigned thereto; an auto-provisioning server in communication with the test head via the DSLAM; and a Test Operations Support System (OSS) in communication with the auto-provisioning server, wherein: the auto-provisioning server and the Test OSS are operative for creating a public IP network therebetween as a function of the DSLAM ID and a public network address assigned to the auto-provisioning server; the auto-provisioning server and the test head are operative for creating a private IP network therebetween that is operative as a function of the DSLAM ID and a private IP address assigned by the auto-provisioning server to the test head; and the auto-provisioning server is operative as a gateway between the public and private IP networks for forwarding a test request from the Test OSS to the test head via the DSLAM based on the DSLAM ID, and for forwarding test results received from the test head via the DSLAM to the Test OSS based on the DSLAM ID.

The telecommunications can further include either an ATM switch or an Ethernet switch operative for routing communications between the auto-provisioning server and the test head.

The telecommunications can further include: a second DSLAM that has a second DSLAM ID assigned thereto; and a second test head coupled to the second DSLAM, the second test head having the VLAN ID and a second MAC address assigned thereto, wherein: the auto-provisioning server is in communication with the second test head via the second DSLAM; the public IP network between the auto-provisioning server and the Test OSS is also operative as a function of the second DSLAM ID and the public network address assigned to the auto-provisioning server; the auto-provisioning server and the second test head are operative for creating a second private IP network therebetween as a function of the second DSLAM ID and a second private IP address assigned by the auto-provisioning server to the test head; and the auto-provisioning server is operative as a gateway between the public IP network and the second private IP network for forwarding a second test request from the Test OSS to the second test head via the second DSLAM based on the second DSLAM ID, and for forwarding second test results received from the second test head via the second DSLAM to the Test OSS based on the second DSLAM ID.

### BRIEF DESCRIPTION OF THE DRAWINGS

FIG. 1 is an exemplary, non-limiting embodiment of a simplified IP/Telephony/Cable television network architecture wherein an embodiment of the present invention is realized/practiced; and

FIG. 2 is an exemplary, non-limiting extension of the network architecture shown in FIG. 1.

### DETAILED DESCRIPTION OF THE INVENTION

The embodiment of the present invention described herein leverages the capabilities of a next generation IP network to automate the steps discussed above. The physical installation of the test head has to occur, but no advance configuration or address assignment is required.

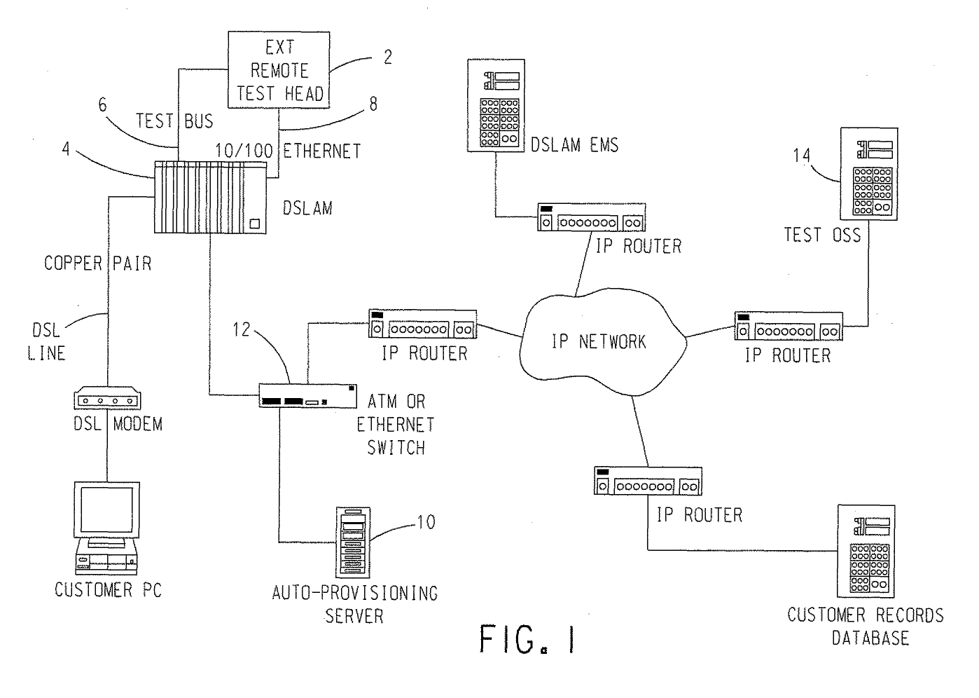

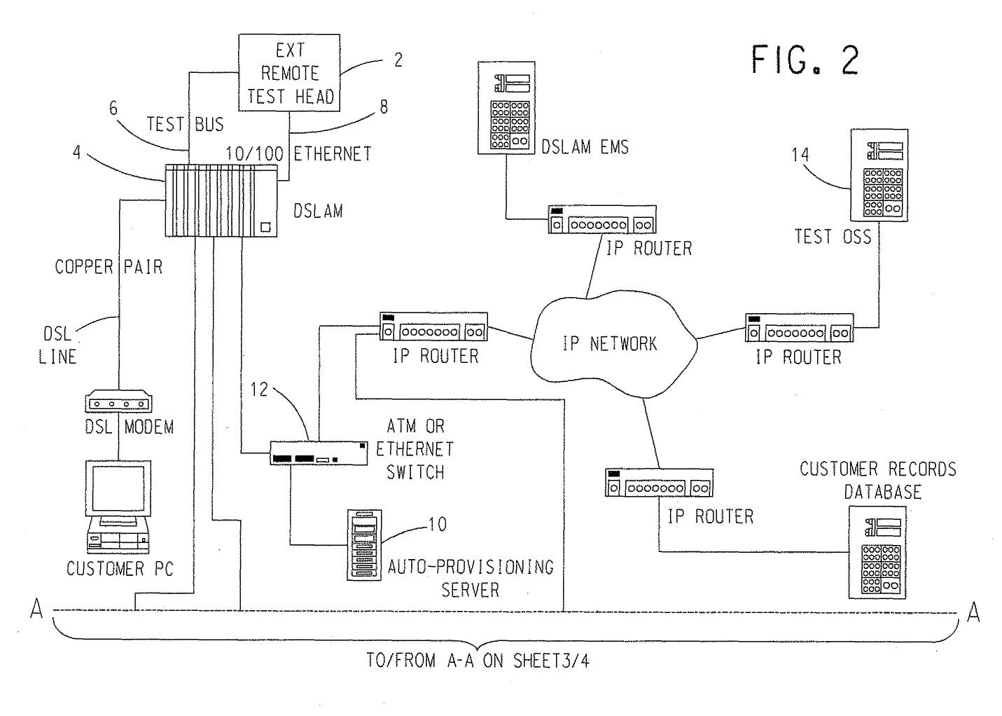

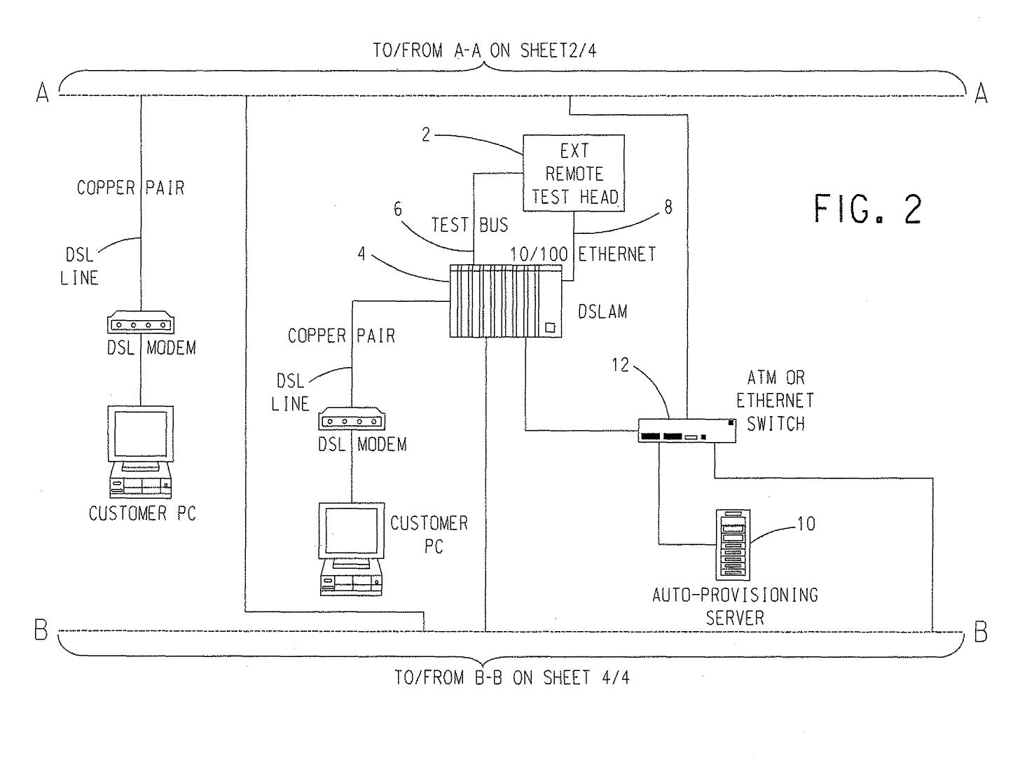

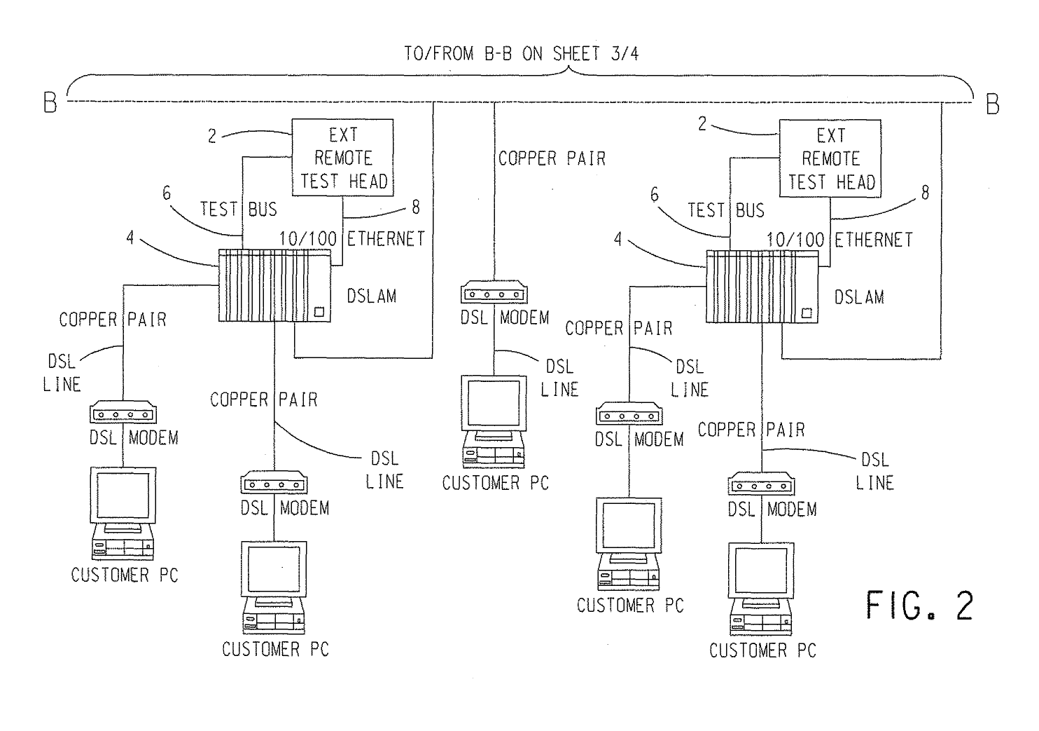

FIG. 1 shows an exemplary, non-limiting embodiment of a simplified IP/Telephony/Cable television network architecture. As would be appreciated by one skilled in the art, the network architecture of FIG. 1 is extensible to a larger network architecture—a non-limiting example of which is shown, for example, in FIG. 2. The network architectures of FIGS. 1 and 2, however, are not to be construed as limiting the invention inasmuch as it is envisioned that one skilled in the art could assemble any suitable and/or desirable IP/Telephony/Cable television network architecture for provisioning. For the purpose of simplicity of description, the embodiment of the present invention described herein will be described primarily with reference to FIG. 1.

With reference to FIG. 1, a test head 2, herein referred to as an EXT, is installed at a DSLAM 4. Each EXT requires electrical power, a two-wire metallic test bus 6 connection with the DSLAM 4 and a 10/100 Ethernet connection 8 with the DSLAM 4, as shown. Once the physical connections are made with the DSLAM 4, the EXT 2 will attempt to automatically add itself to the test network in the manner described hereinafter, thereby minimizing installation time.

Automatic EXT network address assignment involves several steps which will now be described.

Heretofore, test networks were made with separate overlay networks. This added expense to the overall cost to implement the network, but provided a measure of security and performance that was predictable. In the embodiment of the present invention described herein, a virtual overlay network is created in the manner described next via a virtual local area network (VLAN).

In the embodiment of the present invention described herein, the VLAN originates at an EXT 2 connected to a DSLAM 4 and terminates at a so-called Auto-Provisioning Server 10. Multiple VLANs can be created in order to manage a large distributed test network. Each VLAN can handle several EXTs serviced by one Auto-Provisioning Server 10, where each EXT 2 is connected to one DSLAM 4.

An optional ATM switch or Ethernet switch 12 location is a desirable VLAN termination point since this location keeps test traffic from being unnecessarily broadcast throughout the network. Furthermore, this location provides a strategic point to sectionalize a very large distributed network. VLAN terminations can be provisioned at selected locations within the network. In the embodiment of the present invention described herein, the Auto-Provisioning Server 10 is provisioned at each VLAN termination location (e.g., an ATM switch or Ethernet switch 12) to provide management and control of the subtended EXTs. However, the Auto-Provisioning Server 10 itself can be the VLAN termination location when it is in communication with an EXT 2 via the DSLAM 4 without a switch 12 being in the communication path between the Auto-Provisioning Server 10 and the DSLAM 4.

The IEEE 802.1q standard defines 4,096 possible VLAN IDs. In accordance with the embodiment of the present invention described herein, one of these VLAN IDs is dedicated to testing, i.e., the test VLAN ID. This test VLAN ID is preprogrammed in each EXT 2 to be serviced by an Auto-Provisioning Server 10 to enable the EXT 2 to communicate with the Auto-Provisioning Server 10, which is also preprogrammed with the test VLAN ID to enable the Auto-Provisioning Server 10 to communicate back to the EXT 2.

A predetermined port mapping rule is enabled for each DSLAM 4 that is deployed in the network. The port mapping rule of each DSLAM 4 maps the test VLAN ID to a test port of the DSLAM 4, which test port is connected to the Auto-Provisioning Server 10, either directly or via an ATM switch or Ethernet switch 12. Thus, in response to the DSLAM 4 receiving a communication from its EXT 2 directed to the test VLAN ID, the port mapping rule of the DSLAM 4 causes the DSLAM 4 to route the communication to the Auto-Provisioning Server 10 connected to the test port, either directly or via an ATM switch or Ethernet switch 12. Conversely, in response to the DSLAM 4 receiving on its test port a communication from the Auto-Provisioning Server 10 directed to a private IP address assigned to the EXT 2 in a manner to be described hereinafter, the port mapping rule of the DSLAM 4 causes the DSLAM 4 to route the communication to the EXT 2.

When the Auto-Provisioning Server 10 is connected to the test port of the DSLAM 4 via an ATM switch or Ethernet switch 12, a predetermined port mapping rule is also enabled for said switch 12 to map a communication from the EXT 2 including the test VLAN ID to the Auto-Provisioning Server 10. Thus, in response to receiving a communication from the DSLAM 4 directed to the test VLAN ID, the switch 12 utilizes the predetermined port mapping rule to route the communication to the Auto-Provisioning Server 10. Conversely, in response to the switch 12 receiving a communication from the Auto-Provisioning Server 10 directed to a private IP address assigned to the EXT in a manner described hereinafter, the switch 12 routes the communication to the EXT 2 via the DSLAM 4 that services the EXT 2.

Thus, by enabling port mapping rules in the DSLAM 4 and the switch 12, if provided, an EXT 2 can establish communication with an Auto-Provisioning Server 10 via a VLAN created therebetween.

When power is initially applied to an EXT 2 that is coupled to a DSLAM 4, the EXT 2 obtains a private IP address via a Dynamic Host Configuration Protocol (DHCP) request to the Auto-Provisioning Server 10 (DHCP is a TCP/IP protocol that dynamically assigns an IP address). More specifically, the EXT 2 transmits the DHCP request along with its test VLAN ID and its MAC address (a unique hardware address associated with the EXT) to the corresponding DSLAM 4. Each EXT 2 is assigned a unique MAC address prior to installation. In contrast, groups of EXTs 2 serviced by a common Auto-Provisioning Server 10 will all be programmed with the same test VLAN ID.

In response to detecting the test VLAN ID accompanying the DHCP request, the port mapping rule in the DSLAM 4 causes the DSLAM 4 to pass the DHCP request to its test port and, hence, to the Auto-Provisioning Server 10. If a switch 12 is in the communication path between the DSLAM 4 and the Auto-Provisioning Server 10, in response to detecting the test VLAN ID accompanying the DHCP request, the port mapping rule in the switch 12 causes the switch 12 to pass the DHCP request to the Auto-Provisioning Server 10.

Since the EXT 2 is making the DHCP request using its test VLAN ID, only the Auto-Provisioning Server 10 receives the DHCP request.

Desirably, the DSLAM 4 connected to the EXT 2 making the DHCP request has the well-known DHCP option-82 enabled. Accordingly, the DSLAM 4 becomes a DHCP relay agent, adding DSLAM site-dependent data, such as, without limitation, its LAN network ID (DSLAM ID), to the DHCP request before passing the DHCP request to the Auto-Provisioning Server 10.

Upon receipt of the DHCP request, including the VLAN ID and MAC addresses of the EXT 2, and the DSLAM ID of the DSLAM 4 hosting the EXT 2, the Auto-Provisioning Server 10 assigns a private IP address to the EXT 2 and transmits the private IP address to the EXT 2 via the corresponding DSLAM 4 (and switch 12, if provided) utilizing the VLAN ID and the MAC address of the EXT 2. During transmission of the private IP address to the EXT 2, the DSLAM 4 and the switch 12 (if provided) learn of the relationship between the private IP address of the EXT 2 via the VLAN ID and MAC address of the EXT 2 that the DSLAM 4 and the switch 12 (if provided) utilize to route the private IP address to the EXT 2. At this point, the EXT 2 has two network addresses associated therewith. Namely, the combination of the VLAN ID and the EXTs MAC address (a layer 2 network protocol) and the private IP address (a layer 3 network protocol) assigned by the Auto-Provisioning Server 10.

The Auto-Provisioning Server 10 then updates a local database with the private IP address assigned to the EXT 2 and the corresponding DSLAM ID of the DSLAM 4 that services the EXT 2, thus creating a relationship between the private IP address assigned to the EXT 2 and the corresponding DSLAM ID.

At a suitable time, the Auto-Provisioning Server 10 forwards DSLAM IDs of DSLAMs 4 that are addressable by the Auto-Provisioning Server 10 to a centralized Test OSS 14. Upon receipt of this data, the Test OSS 14 records in a database accessible thereto the relationship between each DSLAM ID, the customer circuit(s)' (DSL line(s)) the corresponding DSLAM 4 services, and the LAN address of the Auto-Provisioning Server 10 transmitting this data to the Test OSS 14. The relationship between each DSLAM 4 and the customer circuit(s)' (DSL line(s)) the DSLAM 4 services is programmed in the database accessible to the Test OSS 14 at a suitable time after this relationship has been established.

Thus, the Auto-Provisioning Server 10 acts as a gateway between a public network that includes public, static IP addresses assigned to the Test OSS 14 and the Auto-Provisioning Server 10, and a VLAN private network that includes IP addresses assigned by the Auto-Provisioning Server 10 to EXTs 2 serviced thereby.

When the Test OSS 14 desires to reach a specific EXT 2, the Test OSS 14 sends a test request, including the DSLAM ID of the DSLAM 4 to which a desired EXT 2 is connected, to the LAN address of the Auto-Provisioning Server 10 that services the DSLAM 4. In response to receiving the test request including the DSLAM ID, the Auto-Provisioning Server 10 retrieves from its local database the corresponding private IP address that it assigned to the EXT 2 that is related to the DSLAM ID.

The Auto-Provisioning Server 10 then forwards the test request to the EXT 2 utilizing the EXT's 2 private IP address retrieved from the Auto-Provisioning Server's local database.

Since a VLAN private network is created between the EXT 2 and the Auto-Provisioning Server 10, no public, static IP addresses of EXTs 2 are required to be transmitted between the Test OSS 14 and the Auto-Provisioning Server 10. Since the DSLAM 4 use of option-82 causes the DSLAM's 4 site specific data (DSLAM ID) to be appended to the DHCP request that the DSLAM 4 sends to the corresponding Auto-Provisioning Server 10, the Auto-Provisioning Server 10 learns dynamically where EXTs 2 are being installed. Since the Auto-Provisioning Server 10 forwards DSLAM IDs of DSLAMs 4 that are addressable by the Auto-Provisioning Server 10 to the Test OSS 14, the Test OSS 14 learns how to reach each installed EXT 2.

In response to receiving the test request, the EXT 2 runs one or more tests on one or more customer's DSL line(s) (e.g., copper pair(s)) and reports the test results back to the Test OSS 14 via the VLAN private IP network between the EXT 2 and the Auto-Provisioning Server 10, and the public IP network between the Auto-Provisioning Server 10 and the Test OSS 14.

The following is a list of prerequisites to enable the above-described auto-provisioning process:
The EXT ships from factory with a pre-programmed VLAN ID.
The Auto-Provisioning Server ships from factory with the pre-programmed VLAN ID.
The DSLAM is provisioned by the customer with the appropriate port mapping rule that enables the DSLAM to route communications that include the VLAN ID to the Auto-Provisioning Server.
The ATM or Ethernet switch (if provided) is provisioned by the customer with the appropriate VLAN port mapping rule that enables the switch to route communications that include the VLAN ID to the Auto-Provisioning Server.
The DHCP Option-82 is enabled in each DSLAM.
The Test OSS is programmed with the static LAN address of each Auto-Provisioning Server in the network.

The following is a flow description of the auto-provisioning process for the EXT. This flow description assumes that the VLAN port mapping rule has been provisioned in the DSLAM and the switch (if provided), and that all packets that leave the EXT contain the VLAN ID:
After power is applied to the remote EXT, the EXT sends out a DHCP address request, including the VLAN ID and the MAC address of the EXT, to the DSLAM to which the EXT is connected.
Since DHCP forwarding and Option-82 have been enabled within the DSLAM, the DSLAM will add its site specific data to the DHCP request packet and forward it to the Auto-Provisioning Server or the VLAN port of the ATM or Ethernet switch (if provided). This site specific data includes the DSLAM ID.
The Auto-Provisioning Server will receive the DHCP request packet either directly from the DSLAM or via the switch (if provided). The Auto-Provisioning Server will then assign a private IP address to the EXT, store the DSLAM ID of the DSLAM with the private IP address assigned to the EXT, and then return the private IP address to the EXT via the DSLAM and the switch (if provided) in a DHCP response message that includes the VLAN ID and MAC address of the EXT.
The Auto-Provisioning Server will then transmit a new EXT discovery message to the Test OSS. This EXT discovery message includes the DSLAM ID of the DSLAM that services the EXT.
The Test OSS records the DSLAM ID of the DSLAM that services the EXT along with the Auto-Provisioning Server's IP address that sent the message. The Test OSS now knows that it has to send packets to a specific Auto-Provisioning Server in order to reach a specific DSLAM.
Upon receiving a valid private IP address from the Auto-Provisioning Server, the EXT will turn on an LED to inform the installer that the EXT has been provisioned and is ready to use.

The following is a flow description of the process used by the Test OSS to cause the EXT to run a test. The following steps assume that the Test OSS has been configured with the public, static IP address of each Auto-Provisioning Server in the network:
The Test OSS communicates to each Auto-Provisioning Server and instructs each Server to send EXT discovery messages to one or more Test OSS server IP addresses.
The Test OSS will store EXT discovery messages with the IP address of the Auto-Provisioning Server that sent the message. The EXT discovery message contains the DSLAM ID, of the DSLAMs that service each EXT.
Upon receiving a request to test a customer circuit (e.g., a customer DSL line), the Test OSS will perform a database query of a Customer Records database to find the customer's circuit ID and the DSLAM ID of the DSLAM that services the customer's circuit.
The Test OSS will then request test access via a DSLAM element management system (EMS) using the customer's circuit ID and DSLAM ID of the DSLAM.
Once test access is achieved, the Test OSS will use the DSLAM ID of the DSLAM to locate the Auto-Provisioning Server that services the EXT.
The Test OSS will establish communications with the EXT via the Auto-Provisioning Server. The Auto-Provisioning Server will properly format and forward packets it receives from the Test OSS to the EXT's private IP address over the private IP network that exists between the Auto-Provisioning Server and the EXT, and properly format and forward packets it receives from the EXT's private IP address to the Test OSS over the public IP network that exists between the Auto-Provisioning Server and the Test OSS.
Once the Test OSS has finished testing the circuit, the Test OSS informs the Auto-Provisioning Server to release the EXT.
The Test OSS will communicate to the DSLAM's EMS to release the customer circuit.

The Test OSS establishes IP socket communications with the Auto-Provisioning Server. The Test OSS requests a connection to a specific EXT by providing the Auto-Provisioning Server with the DSLAM ID of the DSLAM to which the EXT is connected. The Auto-Provisioning Server looks up the corresponding private IP address that was assigned to the EXT and attempts to make an IP socket connection to the EXT. Once this connection is made, all subsequent packets which are received by the Auto-Provisioning Server from the Test OSS will be formatted and forwarded to the EXT. This packet formatting includes the following changes:

Test OSS IP Packet:
Source IP Address=Test OSS IP Address
Destination IP Address=Auto-Provisioning Server IP address
Forwarded IP Packet: (Forwarded to Remote EXT)
VLAN ID=Preprogrammed VLAN ID
Source IP Address=Auto-Provisioning Server IP
Destination IP=Remote EXT Address

Packets which are sent from the EXT to the Auto-Provisioning Server are formatted and forwarded to the Test OSS. This packet formatting includes the following changes:

Remote EXT Packet received by the Auto-Provisioning Server:
VLAN ID: Preprogrammed VLAN ID
Source IP Address: EXT private IP Address
Destination IP Address: Auto-Provisioning Server IP Address
Forwarded Test OSS Packet: (Forwarded to Test OSS)
Source IP Address: Auto-Provisioning Server IP Address
Destination LP Address: Test OSS IP Address

The present invention has been described with reference to the preferred embodiment. Obvious modifications and alterations will occur to those of ordinary skill in the art upon reading and understanding the preceding detailed description. It is intended that the invention be construed as including all such modifications and alterations insofar as they come within the scope of the appended claims or the equivalents thereof.

The invention claimed is:

1. A method of testing a telecommunications network, the telecommunications network comprised of a Digital Subscriber Line Access Multiplexer (DSLAM) that has a DSLAM ID assigned thereto, a test head coupled to the DSLAM and including a VLAN ID and a MAC address, and an auto-provisioning server, the method comprising:
(a) causing the test head to request a private IP address from the auto-provisioning server via the DSLAM, said request including the test head's VLAN ID and MAC address;
(b) causing the DSLAM to append its DSLAM ID to the request in step (a);
(c) following steps (a) and (b), causing the auto-provisioning server to assign a private IP address to the test head;
(d) causing the auto-provisioning server to output the private IP address to the test head via the DSLAM utilizing the test head's VLAN ID and MAC address;
(e) causing the test head to associate itself with the output private IP address;
(f) creating in a first database accessible to the auto-provisioning server, a relationship between the private IP address and the DSLAM ID;
(g) creating in a second database accessible to a Test Operations Support System (OSS) coupled to the telecommunications network, a relationship between the DSLAM ID and a network address of the auto-provisioning server;
(h) causing the Test OSS to output to the network address of the auto-provisioning server a test request that includes the corresponding DSLAM ID retrieved from the second database;
(i) in response to the test request including the DSLAM ID, causing the auto-provisioning server to retrieve from the first database the private IP address corresponding to the DSLAM ID;
causing the auto-provisioning server to forward the test request to the test head via the DSLAM utilizing the private IP address; and
(k) in response to the forwarded test request in step (j), causing the test head to run at least one test on a customer circuit coupled to the DSLAM.

2. The method of claim 1, further including between steps (j) and (k), the step of:
causing the DSLAM to connect the customer circuit to the test head based on data regarding the customer circuit included in the test request output by the Test OSS in step (h).

3. The method of claim 2, further including:
(l) following step (k), causing the test head to report the results of the at least one test on the customer circuit to the Test OSS via the DSLAM and the auto-provisioning server; and
(m) following step (l), causing the DSLAM to release the customer circuit.

4. The method of claim 1, wherein the DSLAM includes a rule that routes each communication from the test head that includes the VLAN ID to the auto-provisioning server and routes each communication from the auto-provisioning server that includes the private ID address to the test head.

5. The method of claim 1, wherein:
the telecommunications network includes a network switch in the communication path between the DSLAM and the auto-provisioning server; and
the network switch includes a rule that routes each communication from the DSLAM that includes the VLAN ID to the auto-provisioning server and routes each communication from the auto-provisioning server that includes the private ID address to the DSLAM.

6. The method of claim 1, wherein the customer circuit is a DSL line.

7. A method of testing a telecommunications network, the telecommunications network comprised of a Digital Subscriber Line Access Multiplexer (DSLAM) that has a DSLAM ID assigned thereto, a test head coupled to the DSLAM and including a VLAN ID and a MAC address, and an auto-provisioning server, the method comprising:
(a) creating a public IP network between the auto-provisioning server and a Test Operations Support System (OSS) coupled to the telecommunications network, wherein the auto-provisioning server and the Test OSS each include a unique static IP address on the public IP network;
(b) creating a private VLAN network between the test head and the auto-provisioning server, wherein the test head is assigned a unique dynamic IP address on the private IP network by the auto-provisioning server; and
(c) causing the auto-provisioning server to act as a gateway for the dispatch of data from the test head to the Test OSS, and vice versa, across the private VLAN network utilizing the private IP address and across the public IP network utilizing static IP addresses, wherein the data dispatched from the Test OSS to the test head includes a test request and the data dispatched from the test head to the Test OSS includes test results of a test performed by the test head on a customer circuit coupled to the DSLAM.

8. The method of claim 7, wherein the private VLAN network is created between the test head and the auto-provisioning server via the DSLAM utilizing the VLAN ID, the MAC address and the DSLAM ID.

9. The method of claim 7, wherein step (b) includes the steps of:
the test head requesting a private IP address from the auto-provisioning server via the DSLAM, said request including the test head's VLAN ID and MAC address;
the DSLAM appending its DSLAM ID to the private IP address request;
the auto-provisioning server assigning a private IP address to the test head in response to the server receiving the private IP address request including the DSLAM ID and the test head's VLAN ID and MAC address;
the auto-provisioning server outputting the assigned private IP address to the test head via the DSLAM utilizing the test head's VLAN ID and MAC address; and
the test head associating itself with the output private IP address in response to receiving it from the auto-provisioning server via the DSLAM.

10. The method of claim 7, further including:
creating in a first database accessible to the auto-provisioning server a relationship between the private IP address and the DSLAM ID; and
creating in a second database accessible to a Test Operations Support System (OSS) coupled to the telecommunications network, a relationship between the DSLAM ID and a network address of the auto-provisioning server.

11. The method of claim 10, further including:
causing the Test OSS to output to the network address of the auto-provisioning server a test request that includes the corresponding DSLAM ID retrieved from the second database;
in response to the test request including the DSLAM ID, causing the auto-provisioning server to retrieve from the first database the private IP address corresponding to the DSLAM ID;
causing the auto-provisioning server to forward the test request to the test head via the DSLAM utilizing the private IP address; and
in response to the forwarded test request, causing the test head to run at least one test on a customer circuit coupled to the DSLAM.

12. The method of claim 7, wherein the customer circuit is a DSL line.

13. The method of claim 7, wherein the telecommunications network includes a switch in the communication path between the auto-provisioning server and the DSLAM and operative for passing communications between the auto-provisioning server and the DSLAM.

14. A telecommunications network comprising:
a Digital Subscriber Line Access Multiplexer (DSLAM) that has a DSLAM ID assigned thereto;
a test head coupled to the DSLAM, the test head having a VLAN ID and a MAC address assigned thereto;
an auto-provisioning server in communication with the test head via the DSLAM; and
a Test Operations Support System (OSS) in communication with the auto-provisioning server, wherein:
the auto-provisioning server and the Test OSS are operative for creating a public IP network therebetween as a function of the DSLAM ID and a public network address assigned to the auto-provisioning server;
the auto-provisioning server and the test head are operative for creating a private IP network therebetween that is operative as a function of the DSLAM ID and a private IP address assigned by the auto-provisioning server to the test head; and
the auto-provisioning server is operative as a gateway between the public and private IP networks for forwarding a test request from the Test OSS to the test head via the DSLAM based on the DSLAM TD, and for forwarding test results received from the test head via the DSLAM to the Test OSS based on the DSLAM ID.

15. The telecommunications network of claim 14, further including either an ATM switch or an Ethernet switch operative for routing communications between the auto-provisioning server and the test head.

16. The telecommunications network of claim 14, further including:
a second DSLAM that has a second DSLAM ID assigned thereto; and
a second test head coupled to the second DSLAM, the second test head having the VLAN ID and a second MAC address assigned thereto, wherein:
the auto-provisioning server is in communication with the second test head via the second DSLAM;
the public IP network between the auto-provisioning server and the Test OSS is also operative as a function of the second DSLAM ID and the public network address assigned to the auto-provisioning server;
the auto-provisioning server and the second test head are operative for creating a second private IP network therebetween as a function of the second DSLAM ID and a second private IP address assigned by the auto-provisioning server to the test head; and
the auto-provisioning server is operative as a gateway between the public IP network and the second private IP network for forwarding a second test request from the Test OSS to the second test head via the second DSLAM based on the second DSLAM ID and for forwarding second test results received from the second test head via the second DSLAM to the Test OSS based on the second DSLAM ID.
